(19) United States
(12) Patent Application Publication
(10) Pub. No.: US 2025/0178257 A1
(43) Pub. Date: Jun. 5, 2025

(54) METHOD FOR MANUFACTURING MOLD MEMBER AND METHOD FOR CONTROLLING MANUFACTURING APPARATUS

(71) Applicant: CANON KABUSHIKI KAISHA, Tokyo (JP)

(72) Inventors: DAIKI YAMAMOTO, Kanagawa (JP); YUKUO YAMAGUCHI, Tokyo (JP); RYO SATO, Kanagawa (JP); TOMOAKI KAMAGATA, Kanagawa (JP); SHUICHI HASEGAWA, Kanagawa (JP); Kazunori Iimura, Ibaraki (JP); SATOSHI KAYABA, Ibaraki (JP)

(21) Appl. No.: 18/967,132

(22) Filed: Dec. 3, 2024

(30) Foreign Application Priority Data
Dec. 4, 2023 (JP) 2023-204347

(51) Int. Cl. B29C 45/16

(52) U.S. Cl. CPC B29C 45/1657; B29C 45/1628; B29C 45/1679

(57) ABSTRACT

Disclosed is a method for manufacturing a mold member including: molding a first article and a second article, with the first article remaining in a first mold; molding a third article, which remains in a second mold; assembling the second molded article to the first article; moving at least one of the first mold and the second mold to assemble the second article onto the third article, with the first article remaining in the first mold is opposed to the third article remaining in the second mold; forming a bonding shape portion by combining the first article to which the second article is assembled with the third article; and combining the first mold with the second mold and performing bonding by pouring a bonding resin into the bonding shape portion.

### BACKGROUND

### Field

The present disclosure relates to a method for manufacturing a mold member and a method for controlling a manufacturing apparatus.

### Description of the Related Art

In recent years, a system in which molten resin is used has been adopted for the purpose of the improvement in reliability of bonding and bonding strength and the reduction of apparatus cost in a case where molded articles supplied by a molding method epitomized by injection molding are bonded together. Specifically, a plurality of single parts are molded using an injection molding machine. Then, once a mold is opened to move in such a way that the single parts are opposed to each other, the mold is closed again in that state, and the molded single parts are joined together to form a space for bonding. A molten resin is poured into the space, and bonding is performed. By the adoption of this system, steps up to a bonding step can be completed utilizing a single injection molding machine. The molded articles formed on the mold may be placed in positions that are opposed to each other by moving the mold. Thus, improvement in positional accuracy such as relative positions and parallelism of parts is expected. Further, clamping force of the injection molding machine can be utilized for pressure contact of the parts.

However, in such system, a step in which a molded article is formed and a step in which a molten resin is poured cannot be simultaneously carried out. A method in which a rotatable intermediate mold is provided to form a molded article with one mold of a plurality of molds and a first surface of the intermediate mold. With the molded article being left in the intermediate mold, the intermediate mold is rotated 180 degrees in order to move the molded article to a second surface of the intermediate mold. Pouring of the molten resin is performed using the other mold and a second surface of the intermediate mold may be adopted. Thus, respective steps may proceed on both surfaces in parallel, and the productivity is improved. In this case, it can be considered that parts are assembled on the mold, another part is inserted, or a product is discharged using a supply apparatus on an operational side and a reverse operational side of a molding machine by rotating the intermediate mold 90 degrees each time.

Japanese Patent Laid-Open No. 2018-27686 (hereinafter referred to as Reference 1) discusses a technique relating to a molded article formed by bonding a first part, a second part, and a third part with a bonding resin. Japanese-Patent Laid-Open No. 2016-215561 (hereinafter referred to as Reference 2) discusses a technique in which the position of a mold is relatively moved by a die slide.

In Reference 1, a mold is used for manufacturing a molded article: with a primary molding step in which a first part, a second part, and a third part are molded; an assembly step in which the three parts are assembled in the mold; and a secondary molding step in which a bonding shape portion formed between the assembled three parts is filled with the bonding resin. In the technique of Reference 1, two assembly operations are required to combine the three parts.

Reference 2 discusses that each part can be easily assembled in a case where the position of the mold is relatively moved by the die slide, but in a case where the parts are large in number, as many slide mechanisms as the parts are required, and the mold becomes a complex, large-scale mold.

Where there is an insert member, assembly using a slide cannot be performed. In this case, it is desirable that a molded article is removed from a mold using a robot or the like, and then performing the assembly. In this case, clearance between one part to be assembled to the other part and the other part is needed. Thus, play between the assembled parts arises. This play occurs between combined parts, and as the number of assembly operations is increased, the play becomes greater as a whole.

The three parts which are stacked in the assembly step in Reference 1 are clamped again in the secondary molding step, contained in a space for second molding, and bonded together with bonding resin. However, there is a possibility that because of the play in the assembled parts, the bonding shape portion formed between the assembled parts is not properly formed, and the bonding resin leaks out. Further, there is a possibility that the three parts are not contained in the space in a case of a clamping operation of the secondary molding step, and a molded article is scraped or pinched between molds. For a large number of times of performing the assembly, time which the assembly step takes increases and takt time increases.

### SUMMARY

An aspect of the present disclosure provides a method for manufacturing using a mold having opposing first and second molds to mold at least three molded articles and bonding the molded articles with the bonding resin, the method including molding a first article and a second article, wherein the first article remains in the first mold; molding a third article, wherein the third article remains in the second mold; assembling the second article onto the first article; moving at least one of the first mold and the second mold to assemble the second article onto the third article, wherein the first article which remains in the first mold and to which the second article is assembled is opposed to the third article which remains in the second mold; forming a bonding shape portion by combining the first article to which the second article is assembled with the third article; and combining the first mold with the second mold and performing bonding by pouring the bonding resin into the bonding shape portion.

Further features of the present disclosure will become apparent from the following description of exemplary embodiments with reference to the attached drawings.

### BRIEF DESCRIPTION OF THE DRAWINGS

FIG. 1 is a diagram showing a bonding part;

FIG. 2 is a diagram showing a state immediately before three parts are bonded together with bonding resin;

FIG. 3 is a schematic view of a mold;

FIGS. 4A and 4B are diagrams illustrating a manufacturing step;

FIG. 5 is a diagram illustrating a manufacturing step;

FIG. 6 is a diagram illustrating a manufacturing step;

FIG. 7 is a diagram showing the three parts are assembled;

FIG. 8 is a schematic view of a liquid ejection apparatus;

FIGS. 9A to 9C are diagrams illustrating a connecting portion of a liquid accommodating container;

FIGS. 10A to 10C are diagrams showing a bonding portion used for the connecting portion of the liquid accommodating container;

FIGS. 11A and 11B are diagrams illustrating a manufacturing step;

FIG. 12 is a diagram illustrating a manufacturing step; and

FIG. 13 is a diagram illustrating a manufacturing step.

### DESCRIPTION OF THE EMBODIMENTS

Preferred embodiments of the present disclosure are specifically explained below with reference to the attached drawings. Incidentally, the following embodiments do not limit the present disclosure, and not all combinations of features explained in the following embodiments are essential for the present disclosure. Identical constituent elements are denoted by respective identical reference numbers. Further, the relative positions, the shapes, or the like of constituent elements described in the embodiments are only examples, and the scope of the present disclosure is not intended to be limited to these.

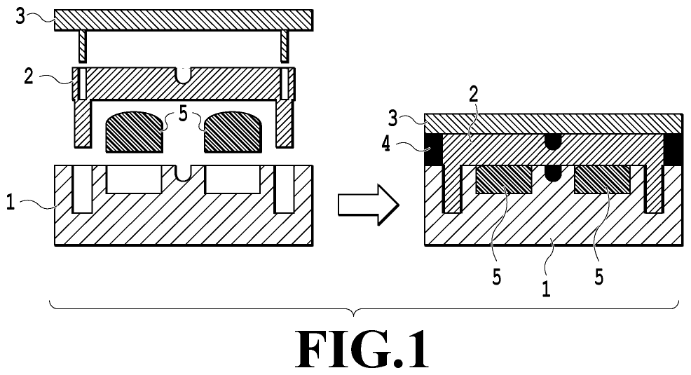

FIG. 1 is a diagram showing a bonding part according to the present embodiment. The bonding part has a configuration in which a first molded article 1, a second molded article 2, and a third molded article 3 are bonded together with bonding resin 4. In a case of bonding, a different type of member (insert member), for example, a rubber part or a filter may be inserted between molded articles. FIG. 1 illustrates an example in which an elastic member 5 is inserted as the insert member.

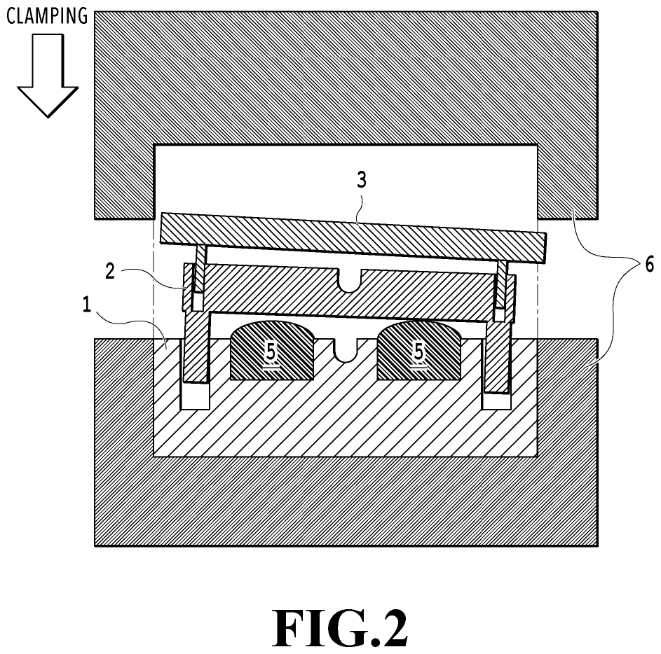

FIG. 2 is a diagram showing a state immediately before the three parts including the first molded article 1, the second molded article 2, and the third molded article 3 are bonded together with the bonding resin. FIG. 2 does not illustrate aspects of the present embodiment, but is provided as an example for comparison. In FIG. 2, the first molded article 1 remains in a mold 6. In this mold 6, another part is assembled to the first molded article 1. As mentioned earlier, assembly needs clearance. Thus, it is possible that the parts may deviate or be inclined by the clearance. As the number of parts to be assembled increases, the clearance occurs between the parts, and overall deviation becomes larger. In this state, the parts have configurations to be contained by being clamped in a space in which the parts are to be bonded with the bonding resin 4. However, in a case where the deviation is too large, it is possible that the molded article is not contained in the space and is pinched by the mold 6. Further, in a configuration of FIG. 2, bonding is performed while the inserted elastic member 5 is compressed by clamping. In this case, in a case of assembly of the second molded article 2, the second molded article 2 is forced, i.e., floated, away from first molded article 1 due to the reaction force of a rubber. Thus, a fitting portion of the second molded article 2 cannot extend too deep into the first molded article to which the second molded article 2 is to be assembled by clamping. A guide formed by a taper is generally provided to the fitting portion for easy assembly. Thus, the clearance increases and the deviation and inclination also increase since the fitting portion cannot extend too deep into the first molded article.

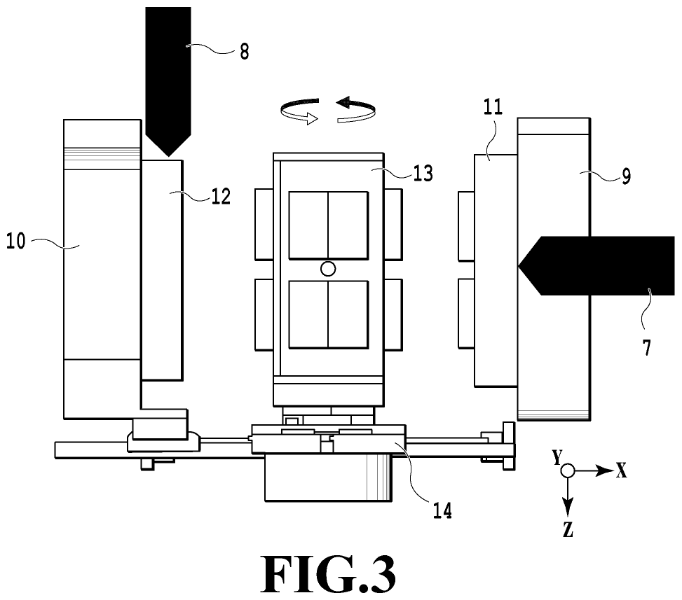

FIG. 3 is a schematic view of a three-plate mold having a first mold 11 attached to a first platen 9 of a molding machine, a second mold 12 attached to a second platen 12 of the molding machine, and an intermediate mold 13 positioned between the first mold 11 and the second mold 12, with the intermediate mold 13 rotating according to the present embodiment. In FIG. 3, an X direction is a mold open-close direction. The intermediate mold 13 rotates 360 degrees around an axis extending in a Z direction orthogonal to the mold open-close direction. The attachment of the intermediate mold 13 to an LM (Linear Motion) guide 14 of the second platen 10 of the molding machine simplifies positioning when clamping. A primary molded article may be molded between the first mold 11 and the intermediate mold 13 as well as between the second mold 12 and the intermediate mold 13. Secondary molding is performed by bonding the primary molded articles together with the bonding resin between the second mold 12 and the intermediate mold 13. The secondary molding is performed by rotating the intermediate mold 13.

An example of a method for manufacturing a mold member with a manufacturing apparatus including such a mold is explained below. The mold member refers to a member manufactured by the use of a mold.

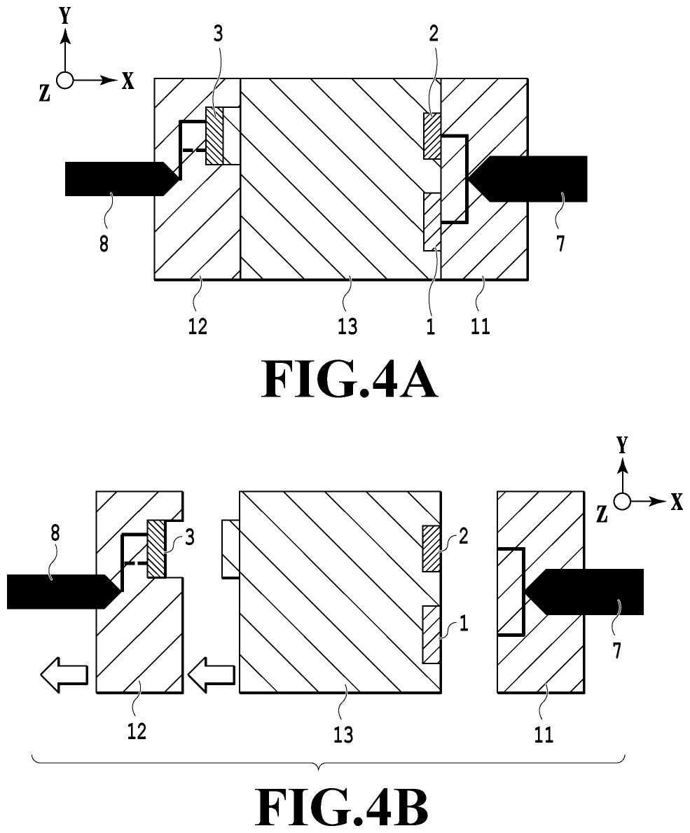

FIGS. 4A and 4B, 5, and 6 are diagrams illustrating manufacturing steps in the present embodiment. FIGS. 4A to 6 are diagrammatic illustrations of the mold (manufacturing apparatus) of FIG. 3 viewed from above. As a first step of molding a molded article, primary molding is performed. In the first step, as shown in FIG. 4A, the first molded article 1 and the second molded article 2 are molded by a first injection unit 7 in a space, i.e. cavity, formed between the first mold 11 and the intermediate mold 13. As shown in FIG. 4A, the third molded article 3 is molded within a part, i.e. a portion, of the space which is formed between the second mold 12 and the intermediate mold 13, and in which the secondary molding is performed by using the molding resin 4. After the molding, as shown in FIG. 4B, the second mold 12 and the intermediate mold 13 move in a minus-X direction, thereby separating each of the molds. In the present embodiment, as shown in FIG. 3, the second platen 10 of the molding machine to which the second mold 12 is provided and the intermediate mold 13 are movable molds. Thus, the second mold 12 and the intermediate mold 13 are configured to be capable of moving together in the mold open-close direction (X direction). After the molding, as shown in FIG. 4B, the first molded article 1 and the second molded article 2 remain in a side of the intermediate mold (intermediate mold 13), and the third molded article 3 remains in a side of the second mold (second mold 12).

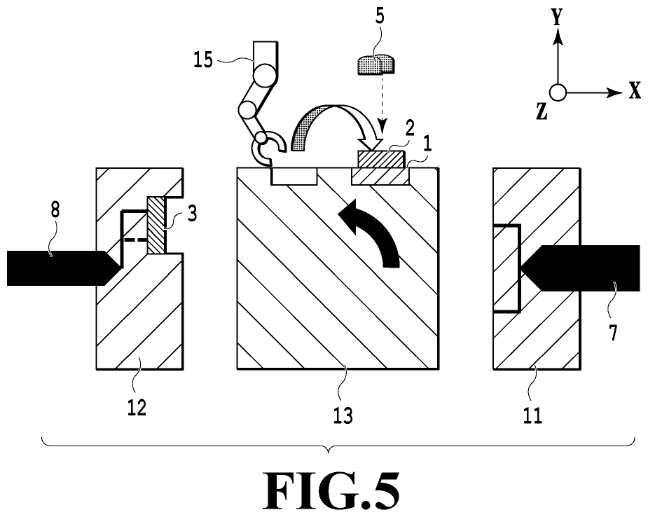

A second step of assembling the molded articles is then performed according to the present embodiment. In the second step, as shown in FIG. 5, the intermediate mold rotates 90 degrees. A robot 15, e.g., a six-axis robot, is provided in a position opposite to a position where the first molded article 1 and the second molded article 2 rotate 90 degrees. As shown in FIG. 5, robot 15 assembles the second molded article 2 onto the first molded article 1, which remains in the intermediate mold 13, as formed in the first step. In this case, the insertion of the elastic member 5 and a different member type, e.g., a filter, is also performed. As described herein, the third molded article 3 is molded in the space in which the secondary molding is performed. Accordingly, the number of times that a part is assembled is reduced by one, compared with a case where all the three parts are molded between the first mold 11 and the intermediate mold 13. Thus, potential deviation of the assembled parts is reduced in the second step.

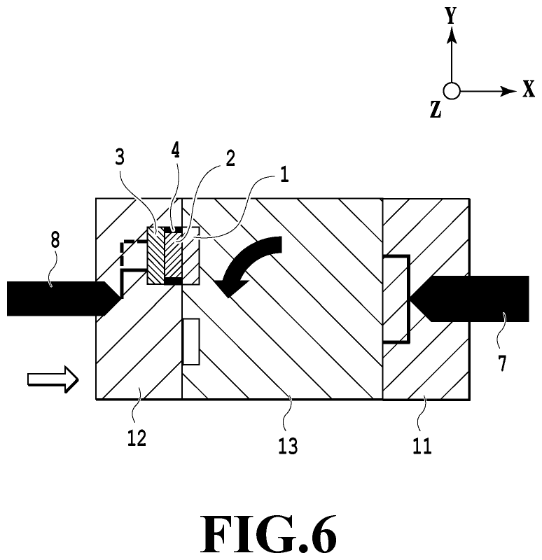

As a third step of the present embodiment, the three parts are bonded by performing secondary molding. In the third step, as shown in FIG. 6, the intermediate mold rotates another 90 degrees from the state of FIG. 5. This rotational movement aligns the space retaining the third molded article 3 molded in the first step with, i.e. opposing, the first molded article 1 to which the second molded article 2 is assembled. Further, as shown in FIG. 6, the second mold 12 (second platen 10 of the molding machine) moves in a direction in which the mold is closed (plus-X direction) to perform another clamping operation. The three parts are assembled in the space by this clamping operation, and the three parts are bonded together by pouring the bonding resin 4 which is a molten resin into the bonding shape portion formed in the three parts.

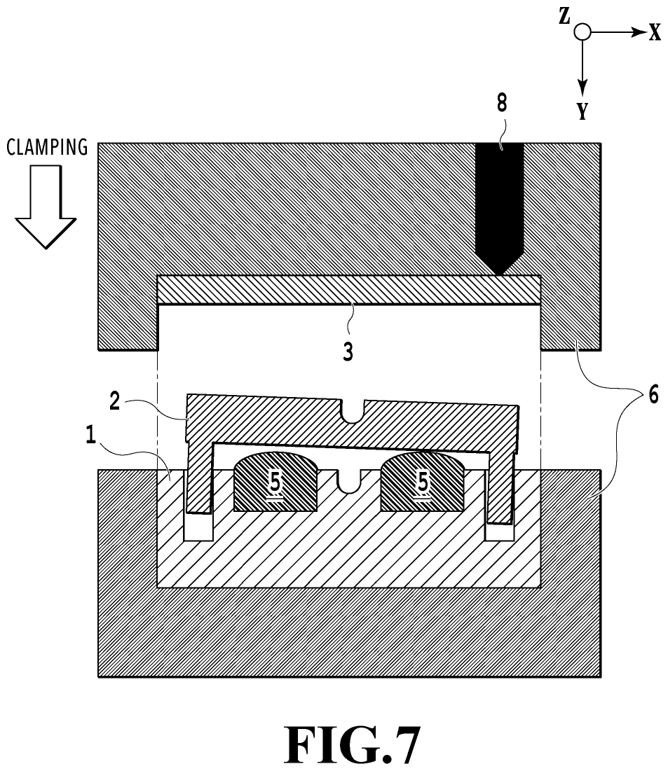

FIG. 7 is a diagram showing that the three parts are assembled in the space for the secondary molding. A side of the second molded article 2 is not retained by the mold. The first molded article 1, the second molded article 2, and the third molded article 3 have a fitting portion which is fitted in a case of assembly. While the clamping operation causes the fitting portion to correct the misalignment and the inclination of the second molded article 2, the second molded article 2, the first molded article 1, and the third molded article 3 are positioned and bonded.

The third molded article 3 is retained in the space for the secondary molding without being taken from the mold (second mold 12) until the third step after molded in the first step. Thus, as shown in FIG. 7, no inclination or misalignment exists in the third molded article 3, for assembly of the third molded article 3 to the first molded article 1 and the second molded article 2.

Incidentally, in an example shown in FIG. 6, the second mold 12, that is, the second platen 10 of the molding machine moves in a plus-X direction, and the intermediate mold 13 also moves in the plus-X direction, and clamping is performed. The intermediate mold 13 is installed in the second platen 10 of the molding machine, and the second mold 12 and the intermediate mold 13 are movable and receive clamping force by being pressed against a side of the first mold 11 (first platen 9 of the molding machine). Therefore, the second mold 12 and the intermediate mold 13 move in the plus-X direction. However, a configuration is not limited to this example. A configuration in which the first mold 11 and the second mold 12 are movable with respect to the intermediate mold 13 may be applicable. In this case, an embodiment in which only the second mold 12 moves in the assembly step shown in FIG. 6 may be applicable as long as the embodiment is an embodiment in which the first mold 11 and the second mold 12 are movable separately.

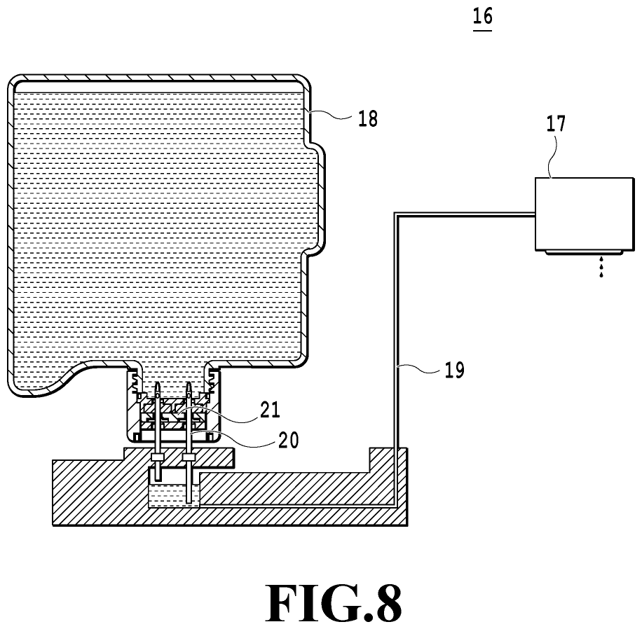

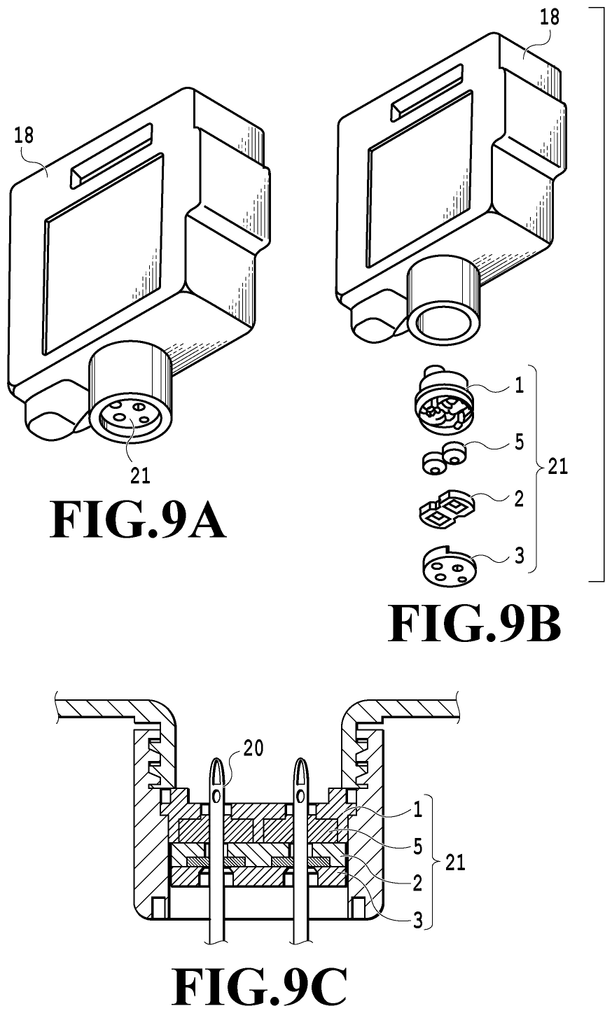

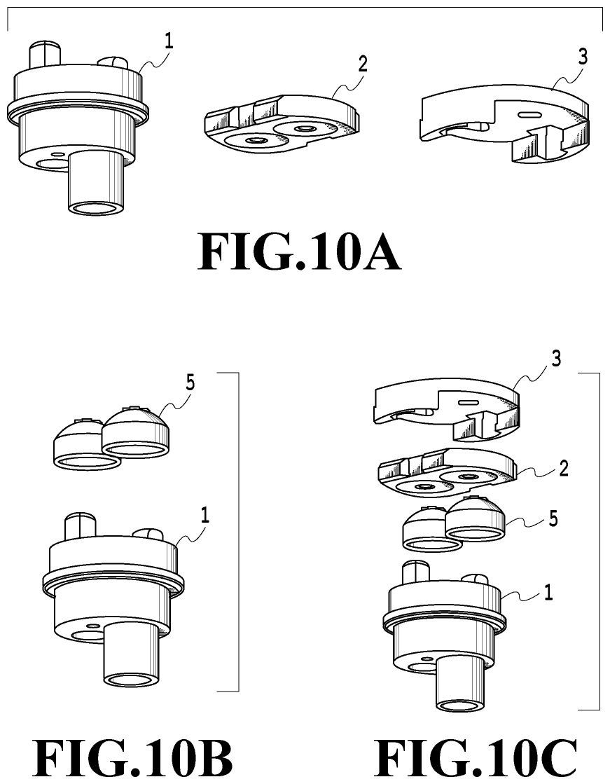

FIG. 8 is a schematic view of a liquid ejection apparatus 16. FIGS. 9A to 9C illustrate a connecting portion 21 of a liquid accommodating container 18. FIGS. 10A and 10B are diagrams showing a bonding part used for the connecting portion 21 of the liquid accommodating container 18. A specific example in which an injection molding machine (manufacturing apparatus) of the present embodiment in the liquid accommodating container 18 of the liquid ejection apparatus 16 is used is explained below with reference to FIGS. 8 to 10B. Incidentally, the liquid ejection apparatus 16 of the present embodiment is an inkjet printer.

As shown in FIG. 8, the liquid ejection apparatus 16 has a liquid ejection head 17, the liquid accommodating container 18, a tube 19, and a hollow needle 20. Incidentally, an example shown in FIG. 8 is a diagrammatic illustration to illustrate a summary and may include a configuration other than these features. The liquid ejection head 17 may be a line liquid ejection head which continuously performs printing in one pass while a plurality of printed media are continuously and intermittently conveyed or a serial liquid ejection head which performs printing by repeating the conveyance of a printed medium and reciprocal scan of the liquid ejection head 17. The liquid ejection apparatus 16 may include a liquid accommodating container 18 in K (black) single color or, in order that full-color printing in CMYK (cyan, magenta, yellow, and black) inks can be performed, may include liquid accommodating containers 18 corresponding to respective colors.

The liquid accommodating container 18 containing liquid is in communication with the liquid ejection head 17 via the tube 19 and the hollow needle 20. The liquid contained in the liquid accommodating container 18 is supplied to the liquid ejection head 17 through the hollow needle 20 and the tube 19.

In a case where the connecting portion 21 or the like of the liquid accommodating container 18 as shown in FIG. 8 is manufactured, the connecting portion 21 is molded as a bonding part formed by the bonding resin. FIG. 9A is a perspective view of the liquid accommodating container 18. FIG. 9B is an exploded perspective view in which a portion of the connecting portion 21 in the liquid accommodating container 18 is disassembled. FIG. 9C is a cross-sectional view of a state where the hollow needle 20 is inserted into the connecting portion 21, that is, a state where the liquid ejection apparatus 16 is equipped with the liquid accommodating container 18. As shown in FIGS. 9A to 9C, the connecting portion 21 has a configuration in which the hollow needle 20 is inserted into the elastic member 5 having a break. Such a configuration provides a role as a valve which enables the connecting portion 21 to retain and supply the liquid. As shown in FIGS. 9B and 9C, the connecting portion 21 is a bonding part including the first molded article 1, the second molded article 2, the third molded article 3, and the elastic member 5.

FIGS. 10A to 10C are diagrams showing the bonding part as the connecting portion 21. As shown in FIG. 10A, the first molded article 1, the second molded article 2, and the third molded article 3 are formed by injection molding. Next, as shown in FIG. 10B, the elastic member 5 is supplied to the first molded article 1. Further, as shown in FIG. 10C, the second molded article 2 and the third molded article are assembled to the first molded article 1 to which the elastic member 5 is supplied and bonded together. The bonding can provide an integral molded article by pouring the bonding resin 4 into the space formed by the molded articles as in the bonding part shown in FIG. 1. In the injection molding machine apparatus of the present embodiment, the third molded article 3 is molded using part of the space in which the secondary molding is performed in addition to the molding of the first molded article 1 and the second molded article 2.

As explained herein, the present embodiment can suppress the play from occurring in the entire combination of the parts and reduce takt time of the assembly step. Specifically, in a bonding part which is obtained by bonding molded articles corresponding to at least three parts and which requires two or more assembly operations in the assembly step, a plurality of parts can be assembled into one in the secondary molding step while the number of times of assemble in the assembly step is reduced. The reduction in the number of times that the assembly is performed makes the assembly itself easy, and reduces play between the combination of the parts. Further, the primary molded article molded in a secondary molding space is bonded without being removed from the mold. That is, the primary molded article molded in the secondary molding space is positioned by the mold and the play does not arise. In addition, the reduction in the number of assembly operations can shorten takt time in the assembly step.

Further, in the above example, a step of manufacturing one part is explained, but a plurality of parts can be continuously manufactured. In other words, in a state of FIG. 6, bonding parts can be continuously manufactured by molding a next part equivalent to FIG. 4A using the first mold 11 and the intermediate mold 13.

Additionally, as explained in the present embodiment, respective steps can be distributed to other surfaces by the use of the intermediate mold 13 which rotates, and thus space efficiency is increased. Further, operations can be performed in parallel on respective surfaces, and thus productivity can be improved.

In the first embodiment, an example in which the primary molding step, the assembly step, and the secondary molding step are performed using the first mold 11, the second mold 12, and the intermediate mold 13 is explained. In the second embodiment, an example in which the primary molding step, the assembly step, and the secondary step are performed without using the intermediate mold is explained. In the second embodiment, either of the first platen 9 of the molding machine in which the first mold 11 is installed or the second platen 10 of the molding machine in which the second mold 12 is installed is a movable platen.

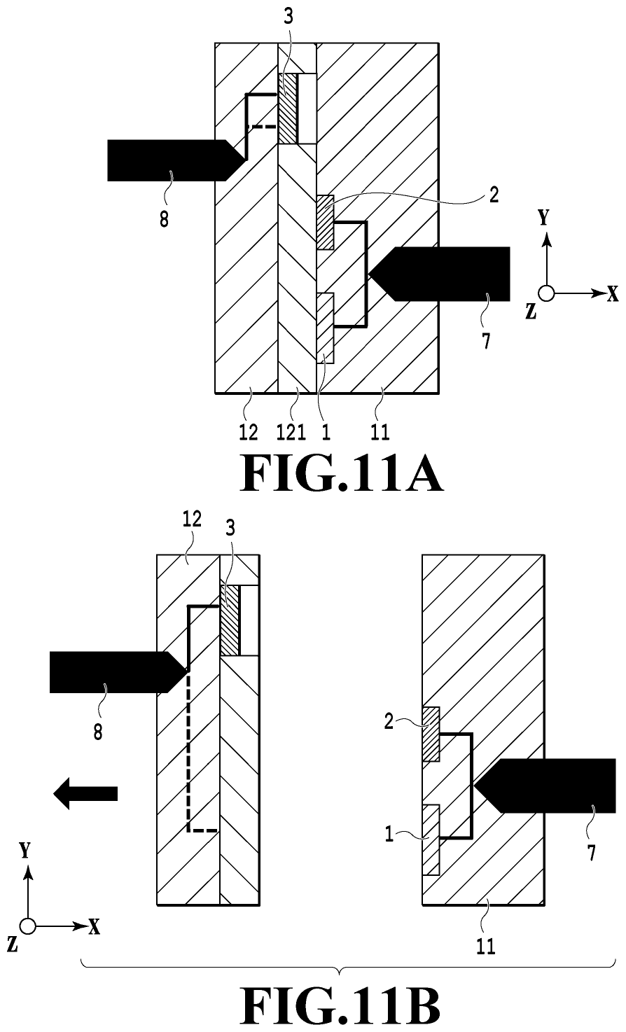

FIGS. 11A and 11B, 12, and 13 are diagrams illustrating manufacturing steps in the second embodiment. FIGS. 11A and 11B, 12, and 13 are diagrammatic illustrations of situations corresponding to FIGS. 4A and 4B, 5, and 6, respectively. In the second embodiment, the second mold 12 has a slide mechanism 121 which can slide.

As the first step, a step of molding a molded article, that is, primary molding is performed. In the first step, as shown in FIG. 11A, the first molded article 1 and the second molded article 2 are molded by the first injection unit 7 in the space formed in the first mold 11. In this case, as shown in FIG. 11A, the third molded article 3 is also molded using part of the space which are formed in the second mold 12 and in which the secondary molding is to be performed with the bonding resin 4. After the molding, as shown in FIG. 11B, each mold is separated as a result of the second mold 12 moving in the minus-X direction. After the molding, as shown in FIG. 11B, the first molded article 1 and the second molded article 2 remain in the first mold 11, and the third molded article 3 remains in the second mold 12.

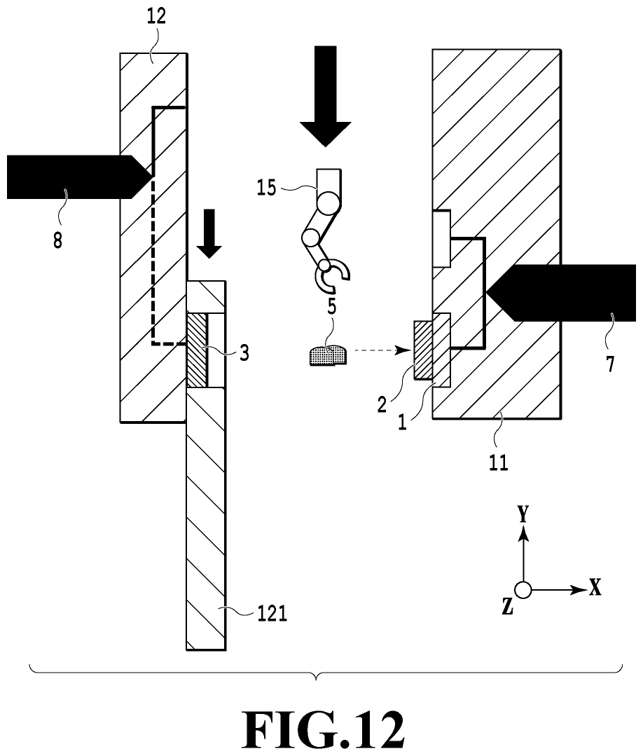

As the second step, assembly of the molded article is performed. In the second step, as shown in FIG. 12, the robot 15 invades the opening between the molds, and then the assembly is performed. As explained in the first embodiment, the insert member such as the elastic member 5 is also assembled in this case. Further, as shown in FIG. 12, the third molded article 3 moves to a position opposite to the first molded article 1 and the second molded article 2 as a result of the slide mechanism 121 moving.

As mentioned earlier, the third molded article 3 is molded using the space in which the secondary molding is performed in the first step. Thus, the number of times that parts are assembled is reduced by one, compared with a case where all the three parts are molded in the first mold 11. Accordingly, the total amount of deviation of assembled parts occurring in the second step can be reduced.

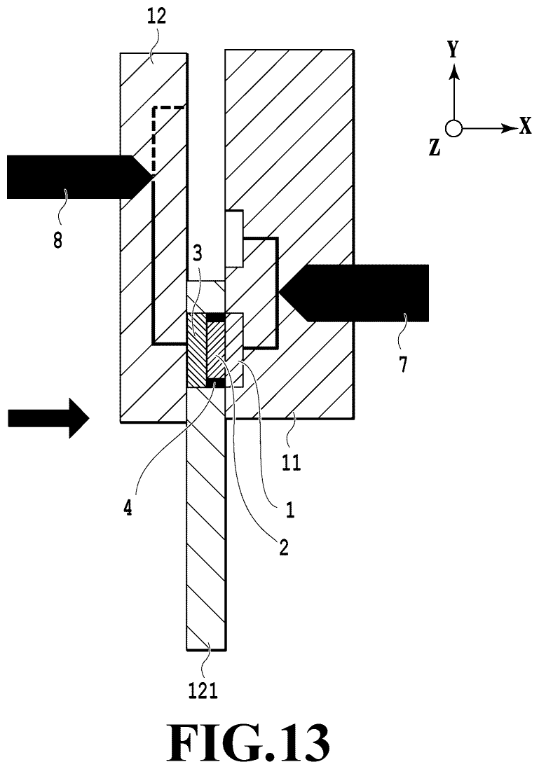

As the third step, the three parts are bonded together, i.e., secondary molding is performed. In the third step, as shown in FIG. 13, clamping is performed as a result of the second mold 12 moving from the state of FIG. 12. This clamping operation causes the three parts to be assembled in the space, and the three parts are bonded together by pouring the bonding resin 4 into the bonding shape portions formed in the three parts.

As explained above, the second embodiment in which the intermediate mold is not used can suppress play that arises between the combination of the parts and reduces takt time of the assembly step.

In the discussion of the first embodiment and the second embodiment, the first mold 11 does not move. However, the first embodiment and the second embodiment are not so limited and movement of the first mold 11 may be applicable. In another embodiment, the first mold 11 moves and the second mold 12 and the intermediate mold 13 do not move. In other words, in the first embodiment, at least one of the first mold 11, the second mold 12, and the intermediate mold 13 has to be configured to be movable. In the second embodiment, at least one of the first mold 11 and the second mold 12 need only be movable.

Further, in the first embodiment and the second embodiment, a method for manufacturing the mold member with the manufacturing apparatus for manufacturing the mold member is explained. Examples explained in the first embodiment and the second embodiment are also methods for controlling the manufacturing apparatus for manufacturing the mold member. The aforementioned steps are performed by controlling a control unit or the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-204347, filed Dec. 4, 2023, which is hereby incorporated by reference wherein in its entirety.

What is claimed is:

1. A method for manufacturing using a mold having opposing first and second molds to mold at least three molded articles and bonding the molded articles with a bonding resin, the method comprising:
molding a first article and a second article, wherein the first article remains in the first mold;
molding a third article, wherein the third article remains in the second mold;
assembling the second article onto the first article;
moving at least one of the first mold and the second mold to assemble the second article onto the third article, wherein the first article which remains in the first mold and to which the second article is assembled is opposed to the third article remaining in the second mold;
forming a bonding shape portion by combining the first article to which the second article is assembled with the third article; and
combining the first mold with the second mold and performing bonding by pouring the bonding resin into the bonding shape portion.

2. The method of claim 1, wherein, in the assembling, the second article is removed the mold for assembly onto the first article.

3. The method of claim 1, wherein, in the bonding, the second article, the first article, and the third article are positioned and bonded together while misalignment and inclination of the second article are corrected by a clamping operation.

4. The method of claim 1, wherein a side of the second article is not retained by the mold during the bonding.

5. The method of claim 1, wherein the assembling comprises inserting an insert member into a primary article.

6. The method of claim 1, wherein the bonding resin is a molten resin.

7. A method for manufacturing using a mold having opposing first and second molds and an intermediate mold provided between the first mold and the second mold to mold at least three molded articles and bonding the molded articles together with a bonding resin, the method comprising:
molding a first article and a second article between the first mold and the intermediate mold, wherein the first article and the second article remain in the intermediate mold;
molding a third article between the second mold and the intermediate mold, wherein the third article remains in the second mold;
assembling the second molded article onto the first article;
moving at least one of the intermediate mold and the second mold to assemble the second article onto the third article, wherein the first article which remains in the intermediate mold and to which the second article is assembled is opposed to the third article remaining in the second mold;
forming a bonding shape portion by combining the first article to which the second article is assembled with the third article; and
combining the intermediate mold with the second mold and performing bonding by pouring the bonding resin into the bonding shape portion.

8. The method of claim 7, wherein the intermediate mold rotates around an axis orthogonal to a mold open-close direction.

9. The method of claim 8, wherein the intermediate mold moves in the mold open-close direction together with the second mold.

10. The method of claim 7, wherein, in the assembling, the second article is removed the mold for assembly on to the first article.

11. The method of claim 7, wherein, in the bonding, the second article, the first article, and the third article are positioned and bonded together while misalignment and inclination of the second article are corrected by a clamping operation.

12. The method of claim 7, wherein a side of the second article is not retained during the bonding by one or more of the first mold, the second mold, or the intermediate mold.

13. The method of claim 7, wherein the assembling comprises inserting an insert member into a primary article.

14. The method of claim 7, wherein the bonding resin is a molten resin.

15. A method for manufacturing using a three plate mold, the method comprising:
molding, in a first mold of the three plate mold, a first article and a second article;
molding, in a second mold of the three plate mold, a third article;
moving at least one of the first mold and the second mold;
assembling the second article onto the first article;
moving at least one of the first mold and the second mold to align the third article with the assembled first article and second article; and
assembling the second article onto the third article, wherein the assembled first article and second article are retained in the first mold and the third article is retained in the second mold.

16. The method of claim 15, wherein the molding of the third article is simultaneously performed with the molding of the first article and the second article.

17. The method of claim 15, wherein the assembled first article and second article is combined with the third article by bonding.
